(19) United States
(12) Patent Application Publication
(10) Pub. No.: US 2026/0089430 A1
(43) Pub. Date: Mar. 26, 2026

(54) AUDIO PROCESSING DEVICE, INFORMATION PROCESSING METHOD, AND EARPIECE

(71) Applicant: Sony Group Corporation, Tokyo (JP)

(72) Inventors: Naoki Shinmen, Tokyo (JP); Masaki Kamata, Tokyo (JP); Atsushi Yamamoto, Tokyo (JP)

(73) Assignee: Sony Group Corporation, Tokyo (JP)

(21) Appl. No.: 18/996,414

(22) PCT Filed: Jul. 4, 2023
(86) PCT No.: PCT/JP2023/024714

§ 371 Date: Nov. 17, 2025

(30) Foreign Application Priority Data
Jul. 26, 2022 (JP) 2022-118835

(51) Int. Cl. H04R 1/10; H04R 29/00

(52) U.S. Cl. CPC H04R 1/1066; H04R 1/1016; H04R 29/001; H04R 2460/15

(57) ABSTRACT

An object is to reduce, for example, a sound leaking through a gap between an earphone or an earpiece and an ear canal.

Provided is an audio processing device including an audio output unit, a housing that houses the audio output unit, a sound guiding portion that guides a sound output from the audio output unit, and a sound deadening structure. The sound deadening structure includes an opening into which a leakage sound, of the sound output from the sound guiding portion, traveling around the outside of a pinna enters.

### TECHNICAL FIELD

The present disclosure relates to an audio processing device, an information processing method, and an earpiece.

### BACKGROUND ART

Among various types of earphones, for example, canal-type earphones are high in sound insulation and are widely accepted in the earphone market because users can concentrate, with such earphones, on sounds they want to listen to. Furthermore, for wireless earphones that have become popular in recent years, an earpiece that fits into an ear canal have a role of supporting an earphone body, so that canal-type earphones with attachable earpieces are often chosen. Examples of an earphone using an acoustic structure including an audio output unit (driver unit) and an earpiece in a manner similar to the above-described earphone include a hearing aid, a sound collector, and the like.

Meanwhile, it is undesirable for a sound played back by an earphone to travel in the opposite direction from an eardrum to the outside of an ear, as the sound become noise for the surroundings. Therefore, for example, the following Patent Literature 1 discloses an earpiece having a sound absorbing structure that absorbs a sound reflected by an eardrum or an ear canal from the sound played back by an audio output unit of an earphone. The structure of such an earpiece prevents a sound from leaking out of an ear.

### CITATION LIST

### Patent Document

Patent Document 1: WO 2016/009520 A

### SUMMARY OF THE INVENTION

### Problems to be Solved by the Invention

When using an earphone, a gap may be generated between an ear canal of a user and an earpiece due to a mismatch between the shape of the ear canal and the shape, size, and the like of the earpiece that fits into the ear canal. In addition to a problem that ambient noise enters from the outside toward the eardrum through such a gap, there is another problem that a sound emitted from the audio output unit leaks out to the outside. In the technology disclosed in the above-described Patent Literature 1, the sound absorbing structure of the earphone is not arranged in the gap, so that the sound cannot be prevented from leaking out of the ear through the gap.

It is therefore an object of the present disclosure to provide an audio processing device and an earpiece that reduce a sound leaking out through, for example, a gap between the earpiece and an ear canal and an information processing method related to the audio processing device.

### Solutions to Problems

According to the present disclosure, provided is, for example, an audio processing device including:
a housing that houses an audio output unit;
a sound guiding portion that guides a sound output from the audio output unit; and
a sound deadening structure.

The sound deadening structure includes an opening into which a leakage sound, of the sound output from the sound guiding portion, traveling around the outside of a pinna enters.

According to the present disclosure, provided is, for example, an information processing method including:
determining whether or not a sealing state is achieved, the sealing state corresponding to a state where a part of an ear canal is sealed by a housing included in an audio processing device or an earpiece attached to the audio processing device; and
making a notification recommending use of a sound deadening structure that reduces a leakage sound leaking through an unsealed part in a case where the sealing state is not achieved.

According to the present disclosure, provided is, for example, an earpiece including:
a tubular base;
an umbrella-shaped portion flared from a front end of the base; and
a wall forming an opening communicating with a space between the base and the umbrella-shaped portion.

### BRIEF DESCRIPTION OF DRAWINGS

FIG. 1 is a diagram referred to when describing the problems to be considered in the present disclosure.

FIG. 2 is a diagram referred to when describing the problems to be considered in the present disclosure.

FIG. 3 is a diagram referred to when describing the problems to be considered in the present disclosure.

FIG. 4 is a perspective view illustrating an external configuration example of an earphone device according to a first embodiment.

FIG. 5 is a cross-sectional view of the earphone device according to the first embodiment with the earphone device fitted in an ear canal.

FIG. 6 is a diagram referred to when describing a sound deadening structure according to the first embodiment.

FIGS. 7A and 7B are diagram referred to when describing the sound deadening structure according to the first embodiment.

FIG. 8 is a diagram referred to when describing a function of the earphone device according to the first embodiment.

FIG. 9 is a diagram for describing a modification of the first embodiment.

FIG. 10 is a cross-sectional view of an earphone device according to a second embodiment with the earphone device fitted in the ear canal.

FIGS. 11A and 11B are diagram referred to when describing a sound deadening structure according to a third embodiment.

FIG. 12 is a diagram referred to when describing a sound deadening structure according to a fourth embodiment.

FIG. 13 is a diagram referred to when describing the sound deadening structure according to the fourth embodiment.

FIG. 14 is a diagram referred to when describing the sound deadening structure according to the fourth embodiment.

FIG. 15 is a diagram illustrating the sound deadening structure according to the fourth embodiment with the sound deadening structure attached to an earpiece.

FIG. 16 is a diagram referred to when describing a sound deadening structure according to a fifth embodiment.

FIG. 17 is a diagram referred to when describing a sound deadening structure according to a sixth embodiment.

FIG. 18 is a diagram referred to when describing a sound deadening structure according to the sixth embodiment.

FIG. 19 is a block diagram for describing an internal configuration example of an earphone device according to a seventh embodiment.

FIG. 20 is a block diagram for describing an internal configuration example of a smartphone according to the seventh embodiment.

FIG. 21 is a flowchart illustrating a flow of processing that is performed between the earphone device and the smartphone according to the seventh embodiment.

FIGS. 22A to 22C are diagrams for describing examples of a user interface (UI) according to the seventh embodiment.

FIG. 23 is a diagram for describing a modification.

FIG. 24 is a diagram for describing a modification.

### MODE FOR CARRYING OUT THE INVENTION

Embodiments and the like of the present disclosure will be described below with reference to the drawings.

Note that the description will be given in the following order.
<Problems to Be Considered in the Present Disclosure>
<First Embodiment>
<Second Embodiment>
<Third Embodiment>
<Fourth Embodiment>
<Fifth Embodiment>
<Sixth Embodiment>
<Seventh Embodiment>
<Modification>

The embodiments and the like to be described below are preferred specific examples of the present disclosure, and the content of the present disclosure is not limited to those embodiments and the like. Note that the sizes, the positional relationships of the members, and the like in the drawings may be exaggerated for clarity of description, and furthermore, there may be a case where only some of the reference numerals are illustrated or the illustration is partially simplified or a case where cross-section hatching is omitted in order to prevent the illustration from becoming complicated. Moreover, in the following description, the same designations or the same reference numerals denote the same or similar members, and redundant descriptions will be omitted as appropriate. Furthermore, directions of up and down, left and right, and the like are defined in consideration of convenience of description, but the present disclosure is not limited by these directions in the description.

### Problems to Be Considered in the Present Disclosure

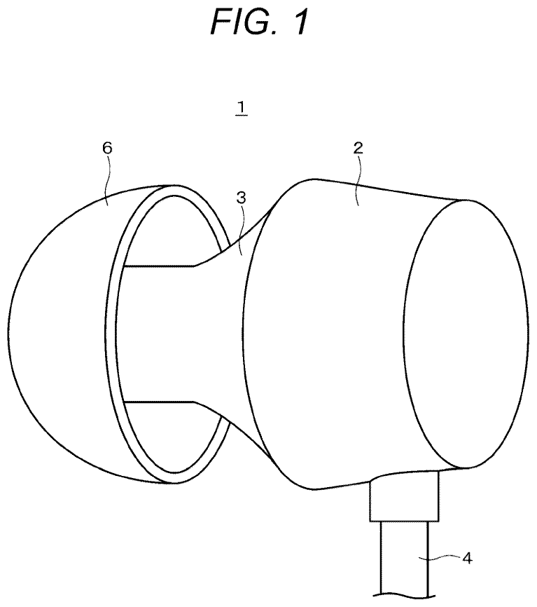

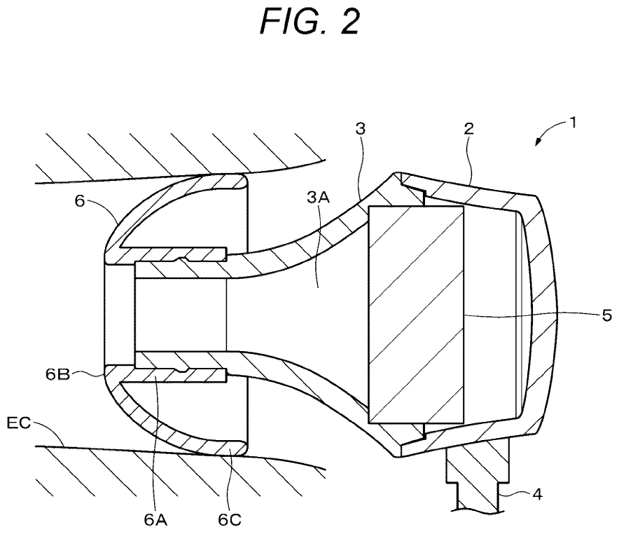

First, to facilitate understanding of the present disclosure, problems to be considered in the present disclosure will be described with reference to FIGS. 1 to 3. FIG. 1 is a perspective view illustrating an external configuration example of a typical canal-type earphone device (earphone device 1). FIG. 2 is a cross-sectional view of the earphone device 1 with the earphone device 1 fitted in an ear canal.

The earphone device 1 includes, for example, a housing 2 that is an exterior component having a truncated cone shape, a cylindrical sound conduit 3 extending from one side surface of the housing 2, and a cable 4 connected to the housing 2. An audio signal is supplied to the earphone device 1 through the cable 4.

As illustrated in FIG. 2, an audio output unit 5 is housed in the housing 2. The audio output unit 5 is connected to the above-described cable 4, and the audio signal is supplied to the audio output unit 5 through the cable 4. The audio output unit 5 plays back a sound corresponding to the audio signal. The sound played back by the audio output unit 5 is emitted into an ear canal EC through a sound guiding portion 3A that is an internal space of the sound conduit 3 and reaches an eardrum (not illustrated). This allows a user to listen to the sound played back by the audio output unit 5.

Meanwhile, generally speaking, when the sound conduit 3 that is a hard member including an acrylonitrile butadiene styrene (ABS) resin or the like is fitted in the ear canal EC as it is, not only the fitting condition of the earphone device 1 becomes unstable, but also the sound conduit 3 comes into direct contact with the ear canal EC, so that the user may feel discomfort or pain. As illustrated in FIG. 2, the earphone device 1 is put in the user's ear with an earpiece 6 attached to the sound conduit 3. The earpiece 6 includes a tubular base 6A and an umbrella-shaped portion 6C that is connected to a front end 6B of the base 6A and is flared from the entire circumference of the base 6A toward the rear (the side remote from the eardrum). A portion around a front end of the sound conduit 3 is fitted in the base 6A.

The earpiece 6 includes a silicone rubber, a urethane-based resin, an acryl-based resin, or the like, and is an elastically deformable attachment member. Since the earpiece 6 is elastically deformable, its diameter slightly increases when the earpiece 6 is fitted onto the sound conduit 3, and the earpiece 6 can be smoothly fitted onto the sound conduit 3. The base 6A of the earpiece 6 has an open end so as not to block the sound emitted from the sound conduit 3 from traveling into the ear. The earpiece 6 may have a mesh-like configuration without an opening. In a case where the earphone device 1 is put in the user's ear, the earpiece 6 is elastically deformed to come into close contact with the ear canal EC of the user's ear. This configuration can prevent the played-back sound from leaking out of the sound conduit 3. Moreover, the use of the earpiece 6 makes it possible to prevent the user from feeling discomfort or pain due to direct contact of the sound conduit 3.

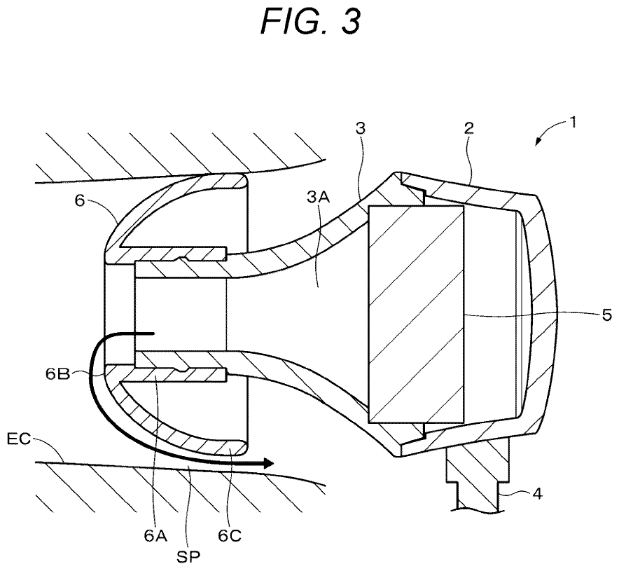

Typically, the earpiece 6 includes a flexible and highly pliant material, but may not perfectly fits with the shape of the ear canal EC to generate a gap (space). For example, in a case where a silicone earpiece 6 is smaller in width than the ear canal EC, a gap is generated, and in addition, an earpiece 6 that is too large than the ear canal EC may cause the umbrella-shaped portion 6C to become crinkled to generate a gap. FIG. 3 illustrates a state where a gap SP is generated when the earphone device 1 is put.

The shape of the ear canal EC is complex and varies greatly among individuals, and it is practically difficult not only to make an earpiece 6 that fits everyone and but also to prepare an earpiece 6 that fits with any shape of ear canal EC. Furthermore, there may be a manufacturing error among earpieces 6. It is therefore impractical to completely eliminate the occurrence of the gap SP.

When the gap SP is formed, a possibility is raised that the sound output from the sound conduit 3 travels along the surface of the umbrella-shaped portion 6C in a direction opposite to the sound radiation direction, that is, around the outside of the pinna instead of the direction toward the eardrum in the ear canal EC, and leaks out to the outside through the gap SP. In FIG. 3, an example of a path of a sound leaking out through the gap SP (hereinafter, also referred to as leakage sound as appropriate) is indicated by an arrow. Note that the component of the leakage sound may also include a sound component reflected by the eardrum out of the sound emitted from the sound conduit 3.

The sound leaking out through gap SP becomes noise for the people around other than the wearer of the earphone device 1. Furthermore, in a case where the earphone device 1 is provided with a noise-cancelling microphone, howling occurs as the leakage sound is picked up by the noise-cancelling microphone, and the noise-canceling function fails to work properly. Furthermore, since the leakage sound travels through the gap SP, the technology disclosed in the above-described Patent Literature 1 cannot reduce the sound pressure of the leakage sound. It is therefore desirable to reduce (reduce to zero or suppress as much as possible) the sound pressure of the leakage sound traveling outward (toward the side remote from the eardrum) through the gap SP. Note that in a case where the earpiece 6 is not used, the gap SP may be generated between the sound conduit 3 and the ear canal EC. The embodiments of the present disclosure will be described in detail below while taking such a viewpoint into consideration.

### First Embodiment

In this embodiment, an earphone device that can be put in the user's ear will be described as an example of the audio processing device. Note that the audio processing device according to the present disclosure is not limited to the earphone device, and is also applicable to a hearing aid, a sound collector, and the like that can be put in the ear.

### Overall Configuration Example

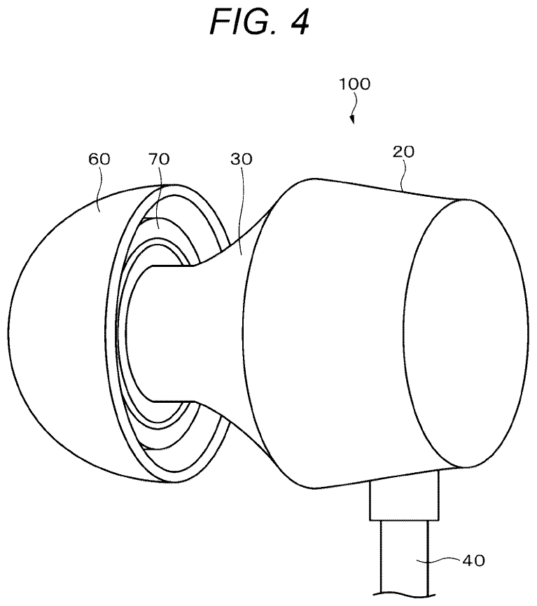

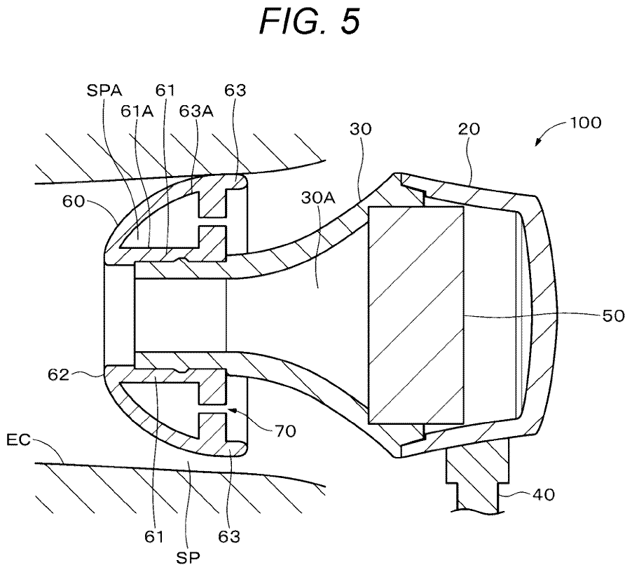

An earphone device (earphone device 100) according to the first embodiment will be described with reference to FIGS. 4 and 5. FIG. 4 is a perspective view illustrating an external configuration example of the earphone device 100. FIG. 5 is a cross-sectional view of the earphone device 100 with the earphone device 100 fitted in the ear canal EC.

The earphone device 100 has almost the same basis configuration of the earphone device 1 described above. The earphone device 100 includes a housing 20 that is an exterior component having a truncated cone shape, a cylindrical sound conduit 30 extending from one side surface of the housing 20, and a cable 40 connected to the housing 20. An electrical signal such as an audio signal or a sound signal is supplied to the earphone device 100 through the cable 40. As illustrated in FIG. 5, an audio output unit 50 is housed in the housing 20. A sound played back by the audio output unit 50 is emitted into the ear canal EC through a sound guiding portion 30A that is an internal space of the sound conduit 30 and reaches an eardrum (not illustrated). This allows the user to listen to the sound played back by the audio output unit 50. The earphone device 100 further includes a sound deadening structure 70. Although details will be described later, the sound deadening structure 70 according to the present embodiment is integrally formed with an earpiece (earpiece 60) attached to the earphone device 100.

The housing 20 includes, for example, an ABS resin. An internal space is formed in the housing 20, and not only the audio output unit 50, but also a battery serving as a power source of the earphone device 100, a wireless communication circuit, a sound processing circuit, and the like can be housed in the internal space.

The sound conduit 30 is a tubular member extending from one side surface of the housing 20. The sound conduit 30 guides the sound output from the audio output unit 50 toward the eardrum. In the present embodiment, the sound conduit 30 is formed separately from the housing 20 and is configured to fit into the housing 20 via a claw section or the like. The sound conduit 30 may be integrally formed with the housing 20. The sound conduit 30 includes, for example, an ABS resin, or alternatively may include metal or the like.

The cable 40 is connected to the audio output unit 50 in the housing 20. The cable 40 led out of the housing 20 is connected to an external device such as a smartphone or a portable audio player that outputs an audio signal through a 3.5 mm plug or the like. Note that earphone device 100 may be a so-called wireless earphone without the cable 40. In a case where the earphone device 100 is configured as a wireless earphone, an amplifier that amplifies an audio signal input to the audio output unit 50, a wireless communication unit that receives a signal from an external device in a wireless manner or the like and outputs the signal to the amplifier, a battery for bringing the amplifier, the wireless communication unit, and the like into operation, and the like are housed in the housing 20.

The audio output unit 50 is a driver unit that generates a sound corresponding to the audio signal input to the earphone device 100. The audio output unit 50 may have a known configuration according to a driving system. For example, the audio output unit 50 may be an electrodynamic speaker, may be of a balanced armature type that transmits power to a diaphragm by vibrating an armature through magnetic induction, or may be a unit using a piezoelectric vibrator. The sound generated by the audio output unit 50 is emitted to the ear canal EC through the sound guiding portion 30A that is the internal space of the sound conduit 30. When the emitted sound reaches the eardrum (not illustrated) through the ear canal EC, the user of the earphone device 100 hears the sound.

The earpiece 60 has nearly a truncated cone shape. As illustrated in FIG. 5, the earpiece 60 includes a tubular base 61 and an umbrella-shaped portion 63 that is connected to a front end 62 of the base 61 and is flared from the entire circumference of the base 61 toward the rear (the side remote from the eardrum). A portion around a front end of the sound conduit 3 is fitted into the base 61. A space SPA is formed between an outer surface 61A of the base 61 and an inner surface 63A of the umbrella-shaped portion 63. The earpiece 60 includes a silicone rubber, a urethane-based resin, an acryl-based resin, or the like, and is an elastically deformable attachment member. Note that FIG. 5 illustrates an example where the gap SP is generated between the earpiece 60 and the ear canal EC (specifically, a predetermined portion of a skin surface in the ear canal EC).

The sound deadening structure 70 reduces the sound pressure of the leakage sound leaking out through the gap SP. For example, the sound deadening structure 70 is integrally formed with the earpiece 60. Therefore, as the material of the sound deadening structure 70, the same material as of the earpiece 60 such as a silicone rubber, a urethane-based resin, or an acryl-based resin can be used.

The sound deadening structure 70 is integrally molded with the earpiece 60 by injection molding or the like. Note that the material of the sound deadening structure 70 and the material of the earpiece 60 may be different. For example, the sound deadening structure 70 include a plastic resin.

### Configuration Example of Sound Deadening Structure

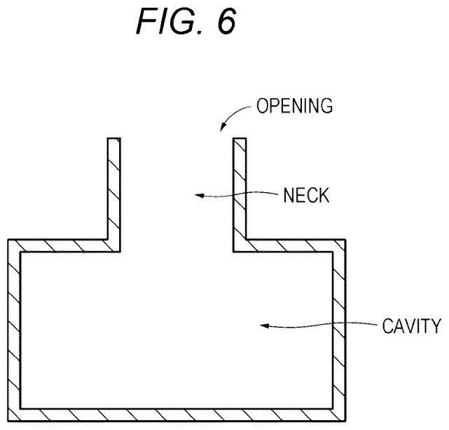

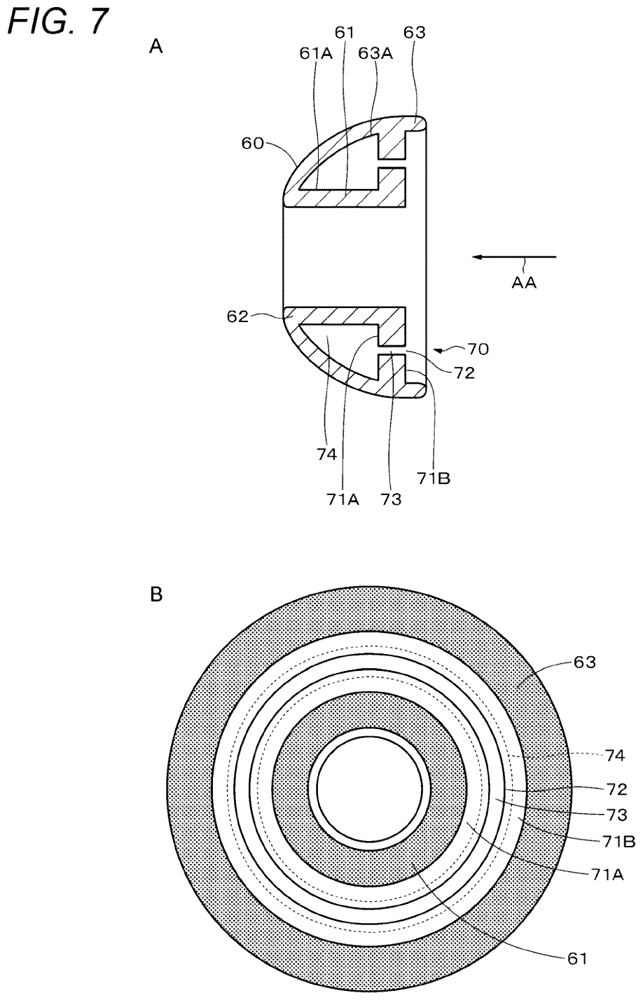

Next, the sound deadening structure 70 according to the present embodiment will be described with reference to FIGS. 6 and 7. The sound deadening structure 70 reduces a leakage sound on the basis of the principle of Helmholtz resonance, for example. FIG. 6 is a schematic diagram (cross-sectional view) of the Helmholtz resonator. The Helmholtz resonator includes an opening, a tubular neck communicating with the opening, and a cavity in a closed space that communicates with an end of the neck (an end remote from the opening) and is larger in volume than the neck. When a sound is taken in through the opening, air in the neck is pushed into the cavity, the pressure in the cavity is increased by the air pushed into the cavity to push the air back again. As this action is alternately repeated, the Helmholtz resonator vibrates and sounds. The Helmholtz resonator has an effect of absorbing sound kinetic energy, focusing on a resonant sound, which produces a sound deadening effect.

Note that, for earphones and headphones, it is known that a leakage sound is a narrowband sound centered around a mid-high frequency range of about several kHz. The size of the opening, the volumes of the neck and the cavity, the volume ratio between the neck and the cavity, and the like are appropriately adjusted so as to deaden such a narrowband sound. As a result, the leakage sound can be effectively reduced.

FIG. 7A is a cross-sectional view of the earpiece 60 and the sound deadening structure 70 formed integrally with the earpiece 60. FIG. 7B is diagram as viewed from a direction of arrow AA in FIG. 7A. For example, with the earpiece 60 attached, the sound deadening structure 70 is arranged in the space SPA formed between the base 61 and the umbrella-shaped portion 63, both belonging to the earpiece 60. For example, as illustrated in FIG. 7A, a wall 71A is provided upright at a predetermined position on the outer surface 61A of the base 61 of the earpiece 60. Furthermore, a wall 71B is provided upright at a predetermined position on the inner surface 63A of the umbrella-shaped portion 63 of the earpiece 60. The wall 71A and the wall 71B are provided upright so as to have a gap between their respective end surfaces. The gap between the wall 71A and the wall 71B (between their respective end surfaces of the walls) serves as a neck 73, and one open end of the neck 73 serves as an opening 72. The other open end of the neck 73 communicates with a closed space defined by the outer surface 61A of the base 61 and the inner surface 63A of the umbrella-shaped portion 63, and this closed space serves as a cavity 74. As illustrated in FIG. 7B, the opening 72 has a ring shape nearly concentric with the base 61. Furthermore, the opening 72 is arranged near an end (open portion) of the umbrella-shaped portion 63. As described above, the size of the opening 72, the volumes of the neck 73 and the cavity 74, the volume ratio between the neck 73 and the cavity 74, and the like are appropriately adjusted so as to reduce the narrowband leakage sound effectively.

### Function

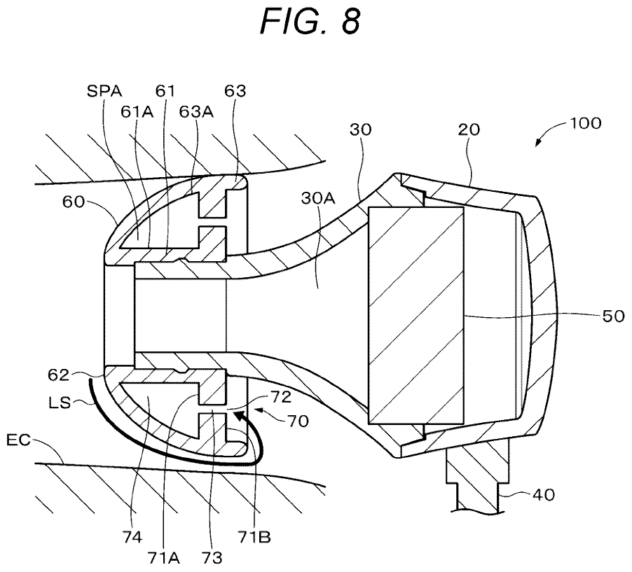

Next, the functions of the earphone device 100 according to the present embodiment will be described with reference to FIG. 8. The sound played back by the audio output unit 50 is emitted into the ear canal EC through the sound conduit 30. The emitted sound partially propagates along the surface of the umbrella-shaped portion 63 and leaks out through the gap SP as the leakage sound LS. Of the sound output from the sound conduit 30, the leakage sound LS traveling around the outside of the pinna (in a direction opposite to the sound radiation direction) enters through the opening 72 of the sound deadening structure 70 into the neck 73 and the cavity 74. The sound pressure of the leakage sound LS is reduced by the sound deadening structure 70 on the basis of the above-described principle of Helmholtz resonance. As a result, the above-described disadvantage caused by the leakage sound LS can be reduced.

### Effects Obtained by Present Embodiment

The earphone device 100 according to the present embodiment can produce the following effects, for example.

Since the leakage sound can be effectively reduced (suppressed) by the sound deadening structure 70, it is possible to suppress the occurrence of noise to the outside and degradation of the noise-canceling function caused by the leakage sound.

Since the opening 72 of the sound deadening structure 70 is located near the propagation path of the leakage sound, the leakage sound can be effectively captured, and the captured leakage sound can be reduced.

It is possible to effectively use the space SPA by providing the sound deadening structure 70 on the back side (in the space SPA) of the umbrella-shaped portion 63 of the earpiece 60. Furthermore, even in a case where the sound deadening structure 70 is provided in the space SPA, the outer shape of the earpiece 60 does not become larger. Furthermore, since the size of the outer shape of the earpiece 60 does not change, even in a case where the sound deadening structure 70 is provided, the fit of the earpiece 60 does not deteriorate.

Furthermore, since the sound deadening structure 70 has no air chamber provided adjacent to the eardrum, propagation of the sound toward the eardrum is not blocked. It is therefore possible to suppress deterioration in sound quality of the sound that the user listens to.

### Modification of First Embodiment

The first embodiment described above can be modified as follows.

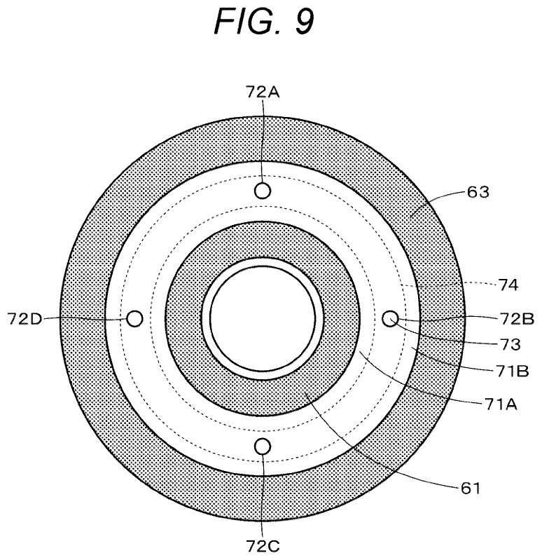

For example, the opening 72 may be configured as holes provided discretely rather than a ring-shaped opening. For example, as illustrated in FIG. 9, the opening may be configured as four circular holes 72A, 72B, 72C, and 72D. Each hole communicates with the corresponding neck and cavity 74. The hole may have a rectangular shape or a polygonal shape rather than a circular shape, and the number of holes may be other than four. For example, all of the four circular holes 72A, 72B, 72C, and 72D may have the same shape, or may have different shapes.

In the above description, the opening 72 is formed by the wall 71A and the wall 71B, but the opening 72 may be formed by either one of the walls. Specifically, the opening 72 may be formed between the end surface of the wall 71A and the inner surface 63A of the umbrella-shaped portion 63, or the opening 72 may be formed between the end surface of the wall 71B and the outer surface 61A of the base 61.

### Second Embodiment

Next, a second embodiment will be described. Note that, in the description of the second embodiment, components that are identical or similar to those in the above description are denoted by the same reference numerals as used in the above description to omit redundant descriptions as appropriate. Furthermore, the matters described in the first embodiment can be applied to the second embodiment unless otherwise specified. The same applies to the other embodiments such as the third embodiment.

In the first embodiment, the sound deadening structure is integrally formed with the earpiece 60. The present embodiment is an example where the sound deadening structure is integrally formed with the sound conduit 30 rather than the earpiece 60.

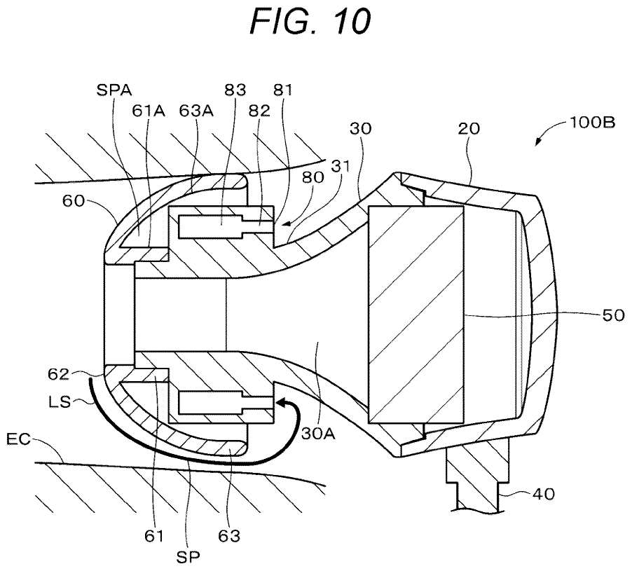

FIG. 10 is a cross-sectional view of an earphone device (earphone device 100B) according to the second embodiment with the earphone device fitted in the ear canal. As illustrated in FIG. 10, a sound deadening structure 80 is provided on the outer surface 31 of the sound conduit 30 and near the front end of the sound conduit 30. The sound deadening structure 80 includes, for example, the same material as of the sound conduit 30, but may include a different material. The sound deadening structure 80 has a size small enough to fit into the space SPA. The sound deadening structure 80 of the present embodiment reduces the leakage sound LS on the basis of the principle of Helmholtz resonance as in the first embodiment. That is, the sound deadening structure 80 includes an opening 81, a neck 82, and a cavity 83. A part of the opening 81 is arranged near the gap SP. The leakage sound LS is taken through the opening 81 into the neck 82 and the cavity 83. Then, the leakage sound LS is reduced on the basis of the principle of Helmholtz resonance.

### Third Embodiment

A third embodiment is an embodiment where the sound deadening structure is integrally formed with neither the earpiece 60 nor the sound conduit 30, but is configured as a separate component, and is detachably attached to, for example, the space SPA.

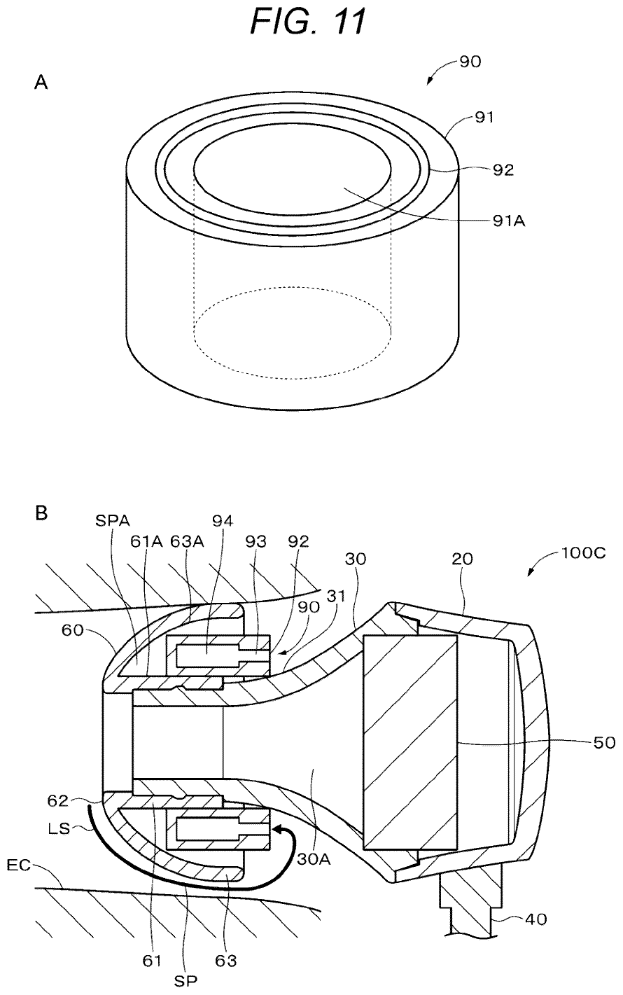

A sound deadening structure (sound deadening structure 90) and an earphone device (earphone device 100C) according to the present embodiment will be described with reference to FIGS. 11A and 11B. As illustrated in FIG. 11A, the sound deadening structure 90 includes a hollow cylindrical body 91 with a hollow portion 91A. The hollow portion 91A is set slightly larger in diameter than a hole formed in the base 61. An opening 92 is formed on one end surface of the body 91. As illustrated in FIG. 11B, a part of the opening 92 is arranged near the gap SP. The opening 92 communicates with a neck 93 formed in the body 91. The neck 93 has the other end communicating with the cavity 94 formed in the body 91.

For example, the sound deadening structure 90 is fitted into the space SPA of the earpiece 60. When the sound deadening structure 90 is press-fitted with the umbrella-shaped portion 63 slightly expanded outward, the sound deadening structure 90 can be stably positioned. After the sound deadening structure 90 is press-fitted into the earpiece 60, the earpiece 60 is attached to a portion around the front end of the sound conduit 30.

The sound deadening structure 90 of the present embodiment reduces the leakage sound LS on the basis of the principle of Helmholtz resonance as in the first embodiment. The leakage sound LS is taken through the opening 92 into the neck 93 and the cavity 94. Then, the leakage sound LS is reduced on the basis of the principle of Helmholtz resonance.

As described above, although the leakage sound LS is a narrowband sound, the frequency band of the leakage sound LS may vary in a manner that depends on the size and shape of the gap SP. According to the present embodiment, it is possible to prepare a plurality of types of the sound deadening structures 90 having different openings 92, necks 93, and cavities 94. That is, sound deadening structures 90 adapted on a one-to-one basis to leakage sounds LS in different frequency bands can be prepared. The use of the optimal sound deadening structure 90 determined on the basis of the user's sense of hearing or an electronic device makes it possible to effectively reduce the leakage sound LS whose frequency band may differ in a manner that depends on differences among individuals.

Note that the sound deadening structure 90 may be detachably attached to a portion other than the space SPA. Making the sound deadening structure 90 detachable from the space SPA allows a reduction in the leakage sound LS without increasing the outer shape of the earphone device 100C.

### Fourth Embodiment

Next, a fourth embodiment will be described. The fourth embodiment is different from the first embodiment and the like in the sound deadening principle of the sound deadening structure. Specifically, a sound deadening structure according to the present embodiment employs a sound deadening method using a resonance tube.

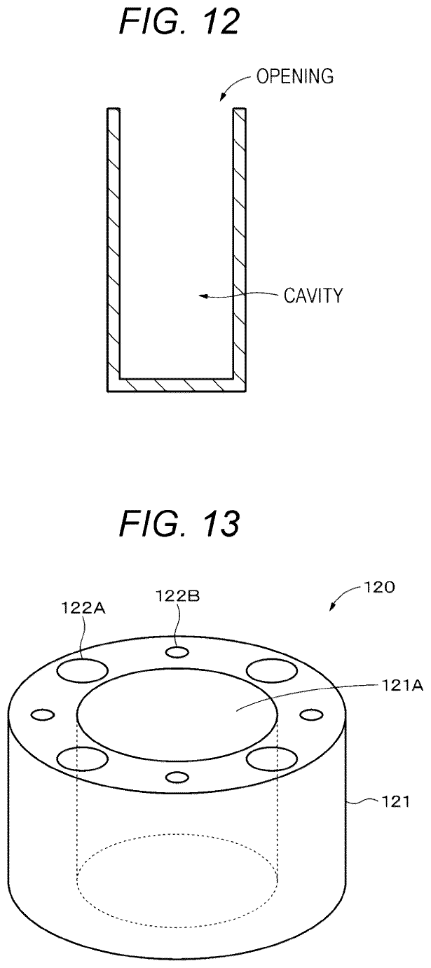

FIG. 12 is a schematic diagram (cross-sectional view) of the resonance tube. As illustrated in FIG. 12, the resonance tube has an opening and a cavity communicating with the opening. The resonance tube is either a tube having no neck the Helmholtz resonator has and having a uniform thickness or a tube having a cavity identical in volume to a neck. In principle, the sound taken into the cavity through the opening of the resonance tube repeatedly collides with a reflected sound in the cavity, so that the sound energy is attenuated, and the sound deadening effect is achieved accordingly. The resonator has an advantage that the resonator is easier to manufacture than the Helmholtz resonator. Furthermore, there is another advantage that a desired resonance frequency can be set by adjusting the diameter of the opening of the resonator and the length (depth) of the cavity of the resonator. That is, it is possible to cope with leakage sounds of different frequencies.

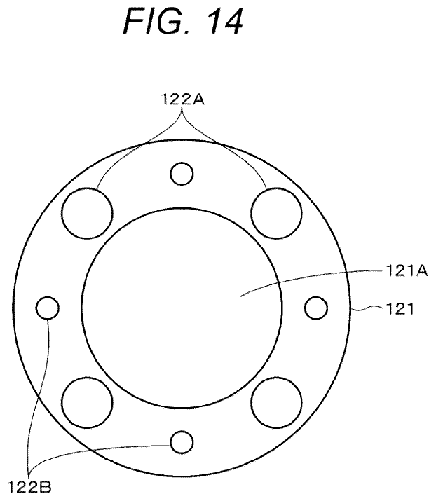

FIG. 13 is a perspective view of the sound deadening structure (sound deadening structure 120) according to the present embodiment, and FIG. 14 is a top view of the sound deadening structure 120. The sound deadening structure 120 includes a hollow cylindrical body 121 with a hollow portion 121A. The hollow portion 121A is set slightly larger in diameter than the hole formed in the base 61 of the earpiece 60. An opening is formed on one end surface of the body 121. For example, as illustrated in FIG. 14, two types of openings (opening 122A and opening 122B) having different diameters are provided on one end surface of the body 121. The opening 122A is set larger in diameter than the opening 122B. Each opening communicates with a corresponding cavity (not illustrated) in the body 121.

That is, the sound deadening structure 120 includes a plurality of resonance tubes of two types. Note that the cavities may have the same or different depths. The resonance tube having the opening 122A is capable of reducing a relatively wideband leakage sound LS, and the resonance tube having the opening 122B is capable of reducing a relatively narrowband leakage sound LS.

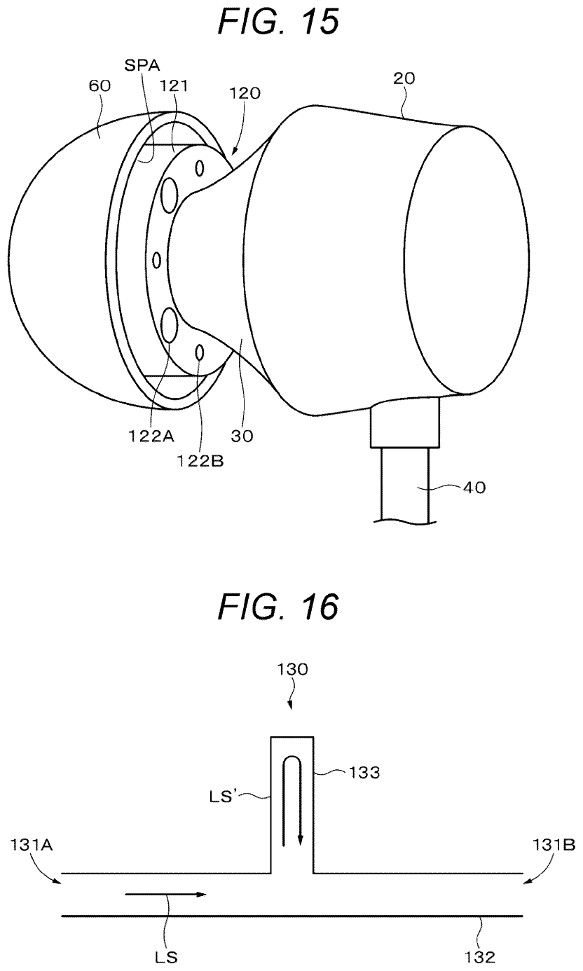

As illustrated in FIG. 15, the sound deadening structure 120 is press-fitted into the space SPA of the earpiece 60. For example, the sound deadening structure 120 is press-fitted into the earpiece 60 such that a surface provided with the opening 122A and the opening 122B is located on the rear side (adjacent to the housing 20). The earpiece 60 into which the sound deadening structure 120 is press-fitted is attached to the portion around the front end of the sound conduit 30.

The functions of the sound deadening structure 120 will be described. The leakage sound LS leaking out through the gap SP enters through the opening 122A and the opening 122B into the cavity communicating with each opening. Then, the leakage sound LS is reduced on the basis of the sound deadening principle of the resonance tube. It is possible to cope with, by providing resonance tubes with openings of different diameters, leakage sounds LS in different bands.

Note that, in the present embodiment, the sound deadening structure 120 has two types of resonance tubes, but may have one type of resonance tube or three or more types of resonance tubes. Furthermore, the sound deadening structure 120 may be integrally formed with the sound conduit 30 or may be integrally formed with the earpiece 60.

### Fifth Embodiment

Next, a fifth embodiment will be described. The fifth embodiment is different from the first embodiment and the fourth embodiment in the sound deadening principle of the sound deadening structure. Specifically, a sound deadening structure according to the present embodiment employs a side branch method.

FIG. 16 is a diagram illustrating a configuration example of the sound deadening structure (sound deadening structure 130) according to the fifth embodiment. The sound deadening structure 130 includes a tubular main tube 132.

The main tube 132 has a first opening 131A and a second opening 131B. The second opening 131B may be closed. A side branch tube 133 is connected to near the center of the main tube 132. The side branch tube 133 is a tubular member extending in a direction approximately orthogonal to an extending direction of the main tube 132 and having a cross-sectional diameter approximately the same as the cross-sectional diameter of the main tube 132.

For example, the leakage sound LS is taken in through the first opening 131A. The leakage sound LS is branched at a connection portion of the side branch tube 133 located in the middle. In the side branch tube 133, the leakage sound LS is reflected in the side branch tube 133, so that a leakage sound LS′ with the phase inverted from the leakage sound LS is generated. It is possible to reduce the leakage sound LS by causing the leakage sound LS and the leakage sound LS′ to interfere with each other at the connection portion of the side branch tube 133.

The first opening 131A of the sound deadening structure 130 is arranged in or near the gap SP. The sound deadening structure 130 may be integrally formed with the sound conduit 30, may be integrally formed with the earpiece 60, or may be attachable to the sound conduit 30 or the earpiece 60.

### Sixth Embodiment

Next, a sixth embodiment will be described. The sixth embodiment is different from the first embodiment, the fourth embodiment, and the fifth embodiment in the sound deadening principle of the sound deadening structure. Specifically, the sound deadening structure according to the present embodiment employs a phase delay method.

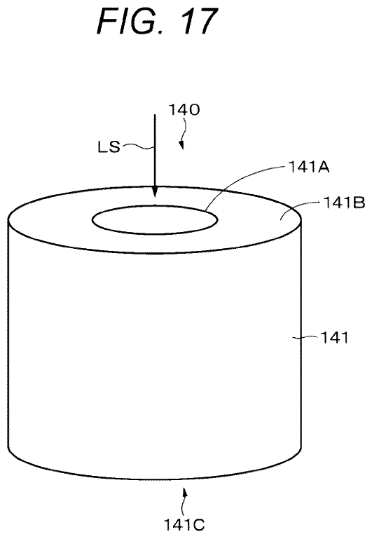

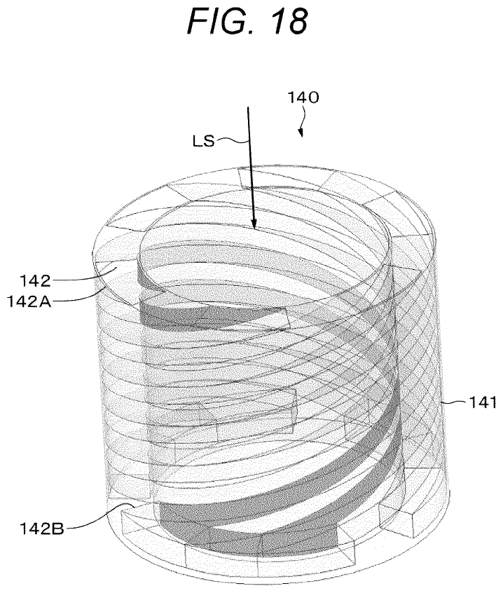

FIG. 17 is a diagram illustrating an example of the appearance of the sound deadening structure (sound deadening structure 140) according to the sixth embodiment, and FIG. 18 is a perspective view of the sound deadening structure 140. The sound deadening structure 140 includes a phase difference tube capable of imparting a phase difference to a leakage sound coming in.

The sound deadening structure 140 includes a hollow cylindrical body 141. The body 141 has an opening 141A at the center and has an upper surface 141B and a bottom surface 141C. As illustrated in FIG. 18, a spiral tubular portion 142 is formed in the body 141. A first open end 142A serving as an inlet of the tubular portion 142 is formed on the upper surface 141B of the body 141, and a second open end 142B serving as an outlet of the tubular portion 142 is formed on the bottom surface 141C of the body 141. In the present embodiment, a plurality of the tubular portions 142 is formed in the body 141. The plurality of tubular portions 142 forms pairs, and each pair of tubular portions 142 are connected to each other at their respective lower portions. In FIG. 18, an example of a pair of tubular portions 142 connected to each other is illustrated with a darker color.

The sound deadening principle of the sound deadening structure 140 will be described. The sound deadening structure 140 is arranged, for example, in or near the gap SP so as to allow the leakage sound LS to be taken into the body 141 through the opening 141A. The leakage sound LS propagates to the lower side of the body 141 through the opening 141A. On the other hand, the leakage sound LS is branched and taken into the tubular portion 142 through the first open end 142A, and is then emitted from the second open end 142B through the tubular portion 142. A propagation path length of the leakage sound LS directly propagating to the lower side of the body 141 is different from a propagation path length of the leakage sound LS passing through the tubular portion 142 (the latter is longer). That is, it is possible to make, by setting different propagation path lengths for the leakage sound LS, the leakage sound LS directly propagating to the lower side of the body 141 different in phase from the leakage sound LS passing through the tubular portion 142. Then, it is possible to reduce the leakage sound by causing the leakage sounds LS having different phases to interfere with each other at the lower side of the body 141.

Note that the number of tubular portions 142 formed in the body 141 may be one. Furthermore, the sound deadening structure 140 is only required to impart a phase difference, the tubular portion 142 may have a shape (for example, a U shape) other than a spiral shape, and the body 141 may have a shape other than a cylindrical shape.

### Seventh Embodiment

Next, a seventh embodiment will be described. In the related art, an earphone device to which an earpiece is attached is put in an ear, and an electronic device automatically determines a sealing state of the earpiece. In a case where the determination result shows insufficient sealing, a notification to encourage replacement with another earpiece is made. There is a possibility that such a determination system requires the user to keep replacing the earpiece as long as sealing is insufficient. Furthermore, in a case where the sealing state is determined with the user's favorite earpiece attached, if the sealing is determined to be insufficient, there is also a possibility that the user hesitates to use the earpiece. The present embodiment is an embodiment that avoids such a problem by recommending the use of the above-described sound deadening structure in a case where the sealing made by the earpiece is insufficient.

### Configuration Example of Earphone Device

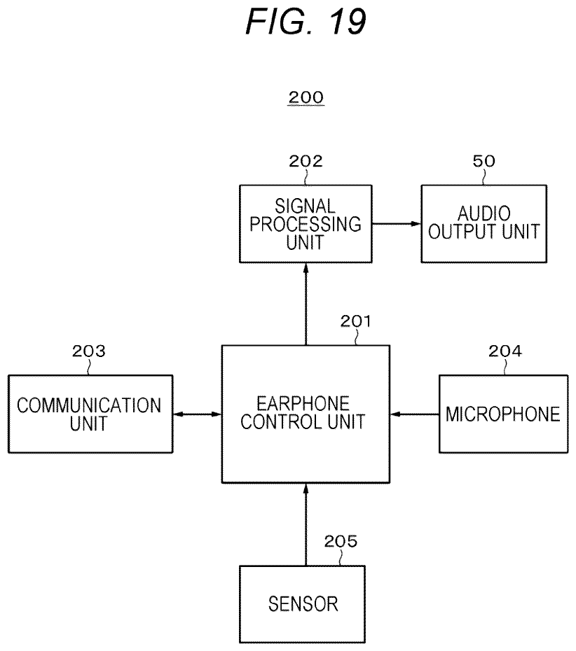

FIG. 19 is a block diagram for describing an internal configuration example of an earphone device (earphone device 200) according to the seventh embodiment. As the earphone device 200, the earphone device 100 or any one of the earphone devices 100A to 100C described above can be used. Note that, in the present embodiment, the earphone device 200 will be described as a wireless earphone.

The earphone device 200 includes, for example, an earphone control unit 201, a signal processing unit 202, a communication unit 203, a microphone 204, a sensor 205, and the audio output unit 50 described above.

The earphone control unit 201 includes, for example, a central processing unit (CPU). Furthermore, the earphone control unit 201 includes a read only memory (ROM) in which a program to be executed by the earphone control unit 201 is stored, a random access memory (RAM) used as a work area, and the like (these memories are not illustrated). The earphone control unit 201 centrally controls each unit of earphone device 200.

The signal processing unit 202 includes, for example, a digital signal processor (DSP). The signal processing unit 202 performs known audio signal processing. For example, the signal processing unit 202 has an equalizer function to adjust the frequency characteristic of an audio signal and a level adjustment function to adjust the level of the audio signal.

The communication unit 203 includes an antenna (not illustrated), and receives a command, a mono or stereo audio signal, or the like from an external electronic device. Examples of the external electronic device include a personal computer, a smartphone, and a portable audio player. Furthermore, examples of the standard for communication performed by the communication unit 203 include wireless local area network (LAN), Bluetooth (registered trademark), WiFi (registered trademark), infrared communication, and the like.

The microphone 204 is, for example, a feedforward microphone that picks up noise outside the housing of the earphone device 200, or a feedback microphone arranged near the audio output unit 50.

The sensor 205 is a generic term for various sensors included in the earphone device 200. Examples of the sensor 205 include a biometric sensor that senses biometric information such as blood pressure and pulse, an image sensor that captures an image, a position sensor and an acceleration sensor, an environment sensor that measures temperature and humidity, and the like.

An operation example of the earphone device 200 will be described. An audio signal input via the communication unit 203 is supplied to the signal processing unit 202 under the control of the earphone control unit 201. After the signal processing unit 202 performs known signal processing on the audio signal, the audio signal is played back by the audio output unit 50.

### Internal Configuration Example of Smartphone

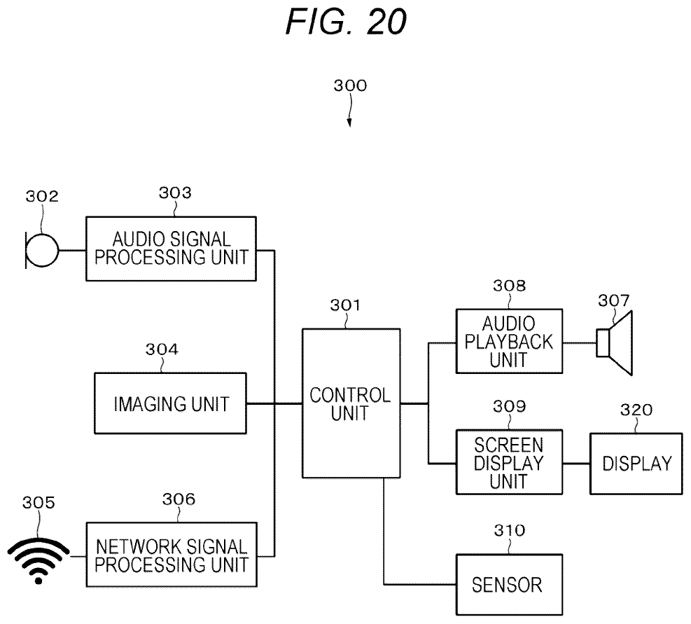

FIG. 20 is a block diagram illustrating an internal configuration example of a smartphone 300, which is an example of the electronic device. The smartphone 300 includes a control unit 301, a microphone 302, an audio signal processing unit 303 connected to the microphone 302, an imaging unit 304, a network unit 305, a network signal processing unit 306 connected to the network unit 305, a speaker 307, an audio playback unit 308 connected to the speaker 307, a display 320, a screen display unit 309 connected to the display 320, and a sensor 310. The audio signal processing unit 303, the imaging unit 304, the network signal processing unit 306, the audio playback unit 308, the screen display unit 309, and the sensor 310 are each connected to the control unit 301.

The control unit 301 includes a central processing unit (CPU) and the like. The control unit 301 includes a ROM in which a program is stored, a random access memory (RAM) used as a work area when the program is executed, and the like (these components are not illustrated). The control unit 301 centrally controls the smartphone 300.

The microphone 302 picks up a user's utterance and the like. The audio signal processing unit 303 performs known audio signal processing on audio data on a sound picked up through the microphone 302.

The imaging unit 304 includes, for example, an optical system such as a lens and an imaging element (these components are not illustrated). As the imaging element, a complementary metal oxide semiconductor (CMOS) sensor or a CCD sensor can be used.

The network unit 305 includes an antenna and the like. The network signal processing unit 306 performs processing such as modulation, demodulation, and error correction on data communicated through the network unit 305.

The audio playback unit 308 performs processing for sound playback from the speaker 307. The audio playback unit 308 performs known audio signal processing such as amplification and D/A conversion, for example.

As the display 320, a liquid crystal display (LCD) or an organic electro luminescence (EL) display can be used. The screen display unit 309 performs known processing for displaying various types of information on the display 320. Note that the display 320 may be configured as a touch panel. In this case, the screen display unit 309 further performs processing for detecting a touch operation position and the like.

The sensor 310 is a generic term for sensors included in the smartphone 300. Specific examples of the sensor 310 include a position sensor, an acceleration sensor, an environment sensor that measures temperature and humidity, a biometric sensor, and the like.

### Flow of Processing

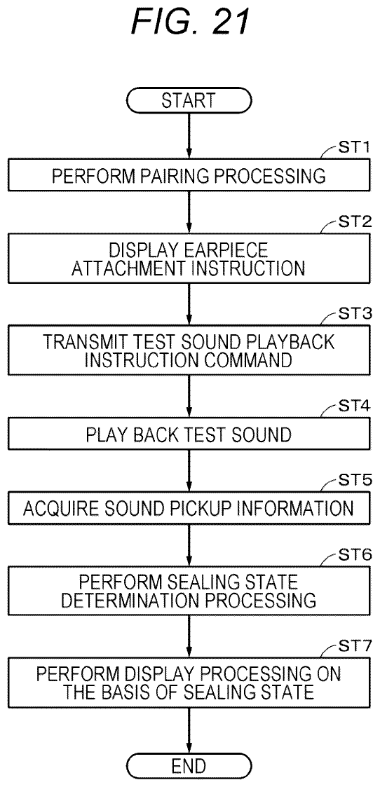

FIG. 21 is a flowchart illustrating a flow of processing that is performed between the earphone device 200 and the smartphone 300.

In step ST1, communication-based pairing processing is performed between the earphone device 200 and the smartphone 300. Then, the processing proceeds to step ST2.

In step ST2, an earpiece attachment instruction is displayed on the display 320 under the control of the control unit 301 of the smartphone 300. The earpiece attachment instruction is, for example, a text display of “attach the earpiece to the earphone device and put the earphone device into the ear”. The earpiece attachment instruction may be notified by voice. Then, the processing proceeds to step ST3.

When a predetermined period of time has elapsed after the earpiece attachment instruction is displayed, the processing of step ST3 is performed. In step ST3, the control unit 301 of the smartphone 300 controls the network unit 305 to transmit, to the earphone device 200, a command for instructing the earphone device 200 to play back a test sound (hereinafter, referred to as test sound playback instruction command as appropriate). Then, the processing proceeds to step ST4.

In step ST4, the test sound playback instruction command is input to the earphone control unit 201 via the communication unit 203. The earphone control unit 201 generates the test sound and generates the test sound from the audio output unit 50. As the test sound, an impulse, an M-sequence signal, a time stretched pulse (TSP) signal, or the like can be used, but, to facilitate the detection of a sound leakage, it is desirable to use a relatively wideband test sound. Note that a normal music signal may be used as the test sound in addition to the impulse, the M-sequence signal, the TSP signal, or the like described above. Furthermore, the test sound is played back while the user is wearing the earphone device, that is, the user is forced to listen to the test sound, so that it is acceptable to sequentially test band-separated signals to incorporate musicality.

The test sound played back from the audio output unit 50 is picked up by the microphone 204. For example, the test sound thus played back is picked up by a feedback microphone of the earphone device 200. The earphone control unit 201 transmits sound pickup information as a sound pickup result to the smartphone 300 via the communication unit 203. Then, the processing proceeds to step ST5.

In step ST5, the network unit 305 receives the sound pickup information transmitted from the earphone device 200. The sound pickup information is subjected to known signal processing by the network signal processing unit 306 and is then input to the control unit 301. As a result, the control unit 301 acquires the sound pickup information. Then, the processing proceeds to step ST6.

In step ST6, the control unit 301 performs sealing state determination processing for determining whether or not the gap SP is generated between the earpiece attached to the earphone device 200 and the ear canal EC, in other words, whether or not the sealing state is achieved. For example, the control unit 301 analyzes the sound pickup information, and in a case where low-frequency sound pressure is lower than high-frequency sound pressure, it is determined that the gap SP is generated and sound leakage occurs, that is, the sealing is insufficient. On the other hand, for example, the control unit 301 analyzes the sound pickup information, and in a case where a difference between the high-frequency sound pressure and the low-frequency sound pressure is equal to or less than a threshold, it is determined that there is substantially no gap SP and no sound leakage, that is, the sealing state is achieved. Note that the earphone device 200 typically includes two earphone devices corresponding to a left (L) channel and a right (R) channel. The sealing state determination is made on the two earphone devices 200 at the same time or at different times. Then, the processing proceeds to step ST7.

In step ST7, display processing based on the sealing state determined in step ST6 is performed. When the control unit 301 controls the screen display unit 309, content based on the sealing state is displayed on the display 320.

### Display Example

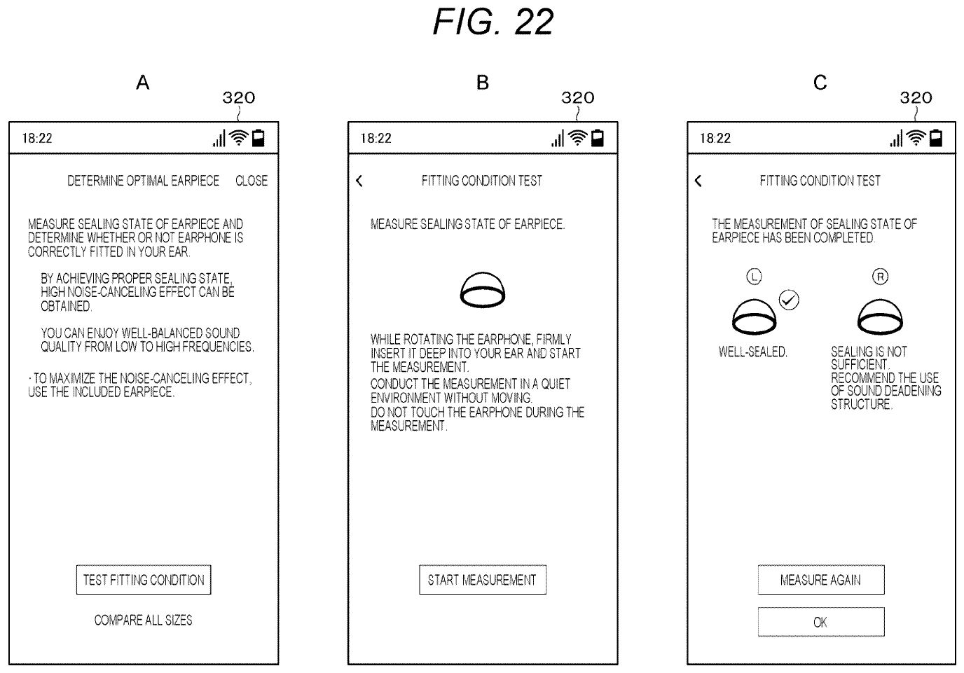

Next, display examples (UIs) based on the sealing state will be described with reference to FIGS. 22A, 22B, and 22C. The following display examples are displayed on the display 320.

FIG. 22A illustrates a display example after the pairing processing (step ST1), for example. A message indicating that it is possible to make the sealing state determination, an effect resulting from determining the sealing state, and the like are displayed on the display 320. When a display section of “test fitting condition” in FIG. 22A is touched, the screen content transitions to FIG. 22B.

FIG. 22B illustrates, for example, content displayed on the display 320 when the processing of step ST2 described above is performed. Precautions for determining the sealing state and the like are displayed on the display 320.

When the display section of “start measurement” in FIG. 22B is touched, the processing of steps ST3 to ST6 described above is performed. Subsequently, when the processing of step ST7 is performed, the content illustrated in FIG. 22C is displayed on the display 320.

As illustrated in FIG. 22C, the result of the sealing state determination processing is displayed on the display 320. In the example illustrated in FIG. 22C, for the L-channel earphone device, a message indicating that the sealing is sufficient without generating the gap SP is displayed, for example. On the other hand, for the R-channel earphone device, a message indicating that the gap SP is generated between the earpiece and the ear canal EC and the sealing is thus insufficient is displayed.

In a case where a leakage sound is detected, in other words, in a case where the sealing is insufficient when the earpiece is used, a message recommending the use of the sound deadening structure is displayed on the display 320. In the example illustrated in FIG. 22C, a message “recommend the use of the sound deadening structure” is displayed. Specific examples of the case where the use of the sound deadening structure is recommended include the following examples. For example, the use of the earpiece (see FIG. 7A) that is identical in size and material to the earpiece used when determining the sealing state and is integrally formed with the sound deadening structure is recommended. As another example, without changing the earpiece used when determining the sealing state, the use of the earphone device (see FIG. 10) including the sound deadening structure is recommended. As another example, the attachment of the sound deadening structure (see FIG. 11A) configured as a separate component to the earpiece used when determining the sealing state is recommended.

According to the present embodiment, in a case where an earpiece packaged together with the earphone device or an earpiece purchased by the user is used, the user can know whether or not the sealing state is achieved (whether or not there is a leakage sound) in a simple manner. Furthermore, in a case where the sealing is insufficient, the message recommending the use of the sound deadening structure is displayed. The user can avoid adverse effects caused by the leakage sound only by using the sound deadening structure in response to such a message. This eliminates the need to prepare different types of earpieces until the determination result shows sufficient sealing. Furthermore, for example, even in a case where the use state of the user's favorite earpiece is determined to show insufficient sealing, it is only required that the sound deadening structure be attached to the earpiece, and the use of the favorite earpiece can be continued.

### Modification of Seventh Embodiment

The present embodiment may be modified as follows.

In the above description, the test sound is picked up by the feedback microphone, but the test sound may be picked up by the feedforward microphone. For example, in a case where a sound having sound pressure higher than or equal to a predetermined threshold is picked up by the feedforward microphone, it may be determined that there is a leakage sound, that is, the sealing is insufficient.

Furthermore, the input to the feedforward microphone may be noise from the outside, so that the determination may be made after correlating the input and a signal output from the feedback microphone or a signal input to an audio output unit and analyzing only a section having a high correlation.

In the above description, the control unit 301 of the smartphone 300 determines the sealing state, but the earphone control unit 201 may determine the sealing state and notify the smartphone 300 of the determination result.

The notification of the sealing state is not limited to a notification made by display, and may be a notification made by voice or the like.

The sealing state may be determined in multiple levels of sealing degree rather than in two levels: sufficient or insufficient. For example, a plurality of thresholds may be set for the sound pressure of the leakage sound, and the sealing state may be determined such that the smaller the sound pressure, the higher the sealing degree. Furthermore, in a case where the sealing cannot be determined to be sufficient when the sealing state is detected multiple times, an earpiece exhibiting a relatively high sealing degree may be selected, and the use of the earpiece may be recommended. In this case, the use of an earpiece that is identical in size to the earpiece exhibiting a relatively high sealing degree and includes the sound deadening structure may be recommended. In a case where such an earpiece is attached, considering the balance of sound heard by the user's eardrum, the low-frequency sound may be adjusted using an equalizer. For example, a signal processing-based adjustment to enhance the low-frequency sound may be performed. The use of the earpiece with the sound deadening structure leads to a reduction in leakage sound, but does not improve the sealing state itself. In a case where only the leakage sound is reduced with insufficient sealing, the sense of the low-frequency sound at the eardrum position is attenuated as compared with a case where the sealing is sufficient, so that it is desirable to perform the above-described adjustment to enhance the low-frequency sound.

### Modification

Although the embodiments of the present disclosure have been described in detail above, the content of the present disclosure is not limited to the above-described embodiments, and various modifications based on the technical idea of the present disclosure are possible.

The present disclosure is also applicable to an earphone device to which no earpiece is attached. For example, the present disclosure is also applicable to an intra-concha earphone device and various types of hearing aids/sound collectors. Here, the various types of hearing aids and sound collectors may have any shape, such as a behind-the-ear type (Receiver-In-Canal) or an in-the-ear type (In-The-Canal/Completely In-Canal).

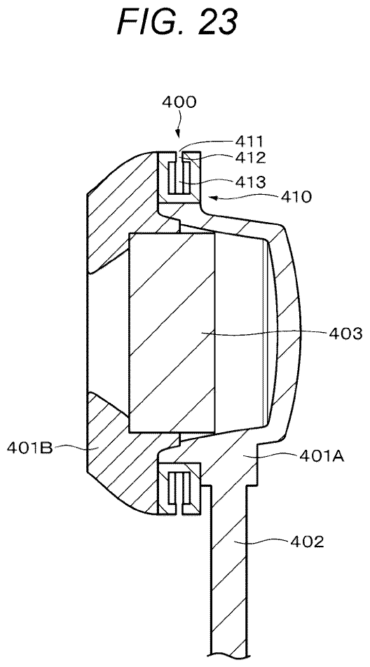

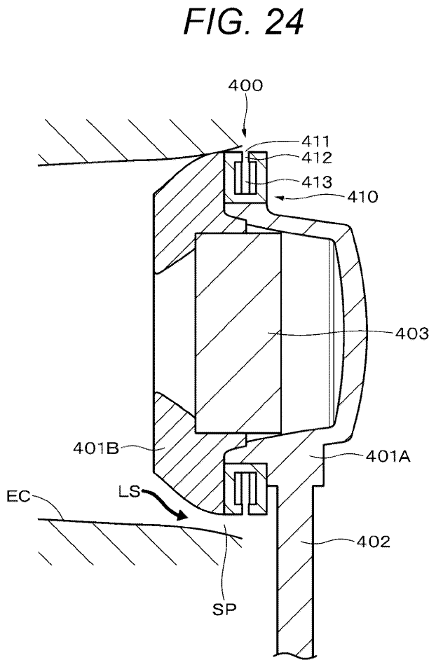

FIG. 23 is a cross-sectional view illustrating a configuration example of an earphone device (earphone device 400) according to a modification. The earphone device 400 includes, for example, a first housing 401A and a second housing 401B that fits tightly with the first housing 401A. A cable 402 is connected to the first housing 401A. An audio output unit 403 is housed in an internal space formed by the first housing 401A and the second housing 401B. Note that the first housing 401A and the second housing 401B may be integrally formed.

The sound deadening structure 410 is provided near the fitting portion between the first housing 401A and the second housing 401B, more specifically, near a flange portion of the cylindrical first housing 401A. The sound deadening structure 410 reduces the leakage sound LS on the basis of the principle of Helmholtz resonance, for example. The sound deadening structure 410 may be detachably attached to either or both of the first housing 401A and the second housing 401B. The sound deadening structure 410 includes, for example, an opening 411, a neck 412, and a cavity 413. The opening 411 is formed to open outward in cross-sectional view. Note that the sound deadening structure 410 may be a structure that deadens a sound by a method other than the principle of Helmholtz resonance.

FIG. 24 is a diagram illustrating a state where the earphone device 400 is fitted in the ear canal EC. For example, a gap SP is generated between the second housing 401B and the ear canal EC. A leakage sound LS leaks out through the gap SP. The sound deadening structure 410 is, however, arranged near the propagation path of the leakage sound LS, so that the leakage sound LS can be reduced by the sound deadening structure 410.

It is also possible to determine, by applying the technology of the seventh embodiment described above to earphone device 400, the sealing state of the earphone device 400. In a case where the sealing state is insufficient, for example, a message encouraging the attachment of the sound deadening structure 410 to the first housing 401A (or the second housing 401B) is displayed. As described above, the present disclosure is also applicable to an earphone device to which no earpiece is attached.

The audio processing device according to the present disclosure can also be configured as a hearing aid, a sound collector, or a headphone. Furthermore, in a case where the attributes of the user (e.g., elderly) are somewhat fixed, as in the case of hearing aids, it is only required that the resonance tube have one type of opening. Furthermore, the size of the opening may be set in relative proportion to the outer shape of the earpiece.

The configurations, methods, steps, shapes, materials, numerical values, and the like described in the above embodiments are merely examples, and different configurations, methods, steps, shapes, materials, numerical values, and the like may be used as necessary. For example, the material of the housing and the sound conduit is not limited to the ABS resin, and one of various other resins such as polypropylene and polystyrene may be used. The above embodiments and modifications may be appropriately combined.

The present disclosure may have the following configurations.

(1) An audio processing device including:
an audio output unit;
a housing that houses the audio output unit;
a sound guiding portion that guides a sound output from the audio output unit; and
a sound deadening structure, in which
the sound deadening structure includes an opening into which a leakage sound, of the sound output from the sound guiding portion, traveling around an outside of a pinna enters.

(2) The audio processing device according to (1), in which
an earpiece is attachable to the sound conduit, and
the sound deadening structure is arranged in a space formed between a base and an umbrella-shaped portion, both belonging to the earpiece, with the earpiece attached.

(3) The audio processing device according to (2), in which
the sound deadening structure is integrally formed with the earpiece attached to the sound conduit.

(4) The audio processing device according to (2), in which
the sound deadening structure is integrally formed with the sound conduit.

(5) The audio processing device according to (2), in which
the sound deadening structure is detachably attached to the space.

(6) The audio processing device according to (1), in which
the sound deadening structure is integrally formed with the housing.

(7) The audio processing device according to any one of (1) to (6), in which
a level of the leakage sound entering through the opening is reduced by the sound deadening structure.

(8) The audio processing device according to any one of (1) to (7), in which
the sound deadening structure includes a neck communicating with the opening, and a cavity having a volume equal to or larger than a volume of the neck.

(9) The audio processing device according to any one of (1) to (7), in which
the sound deadening structure includes a cavity communicating with the opening.

(10) The audio processing device according to any one of (1) to (7), in which
the sound deadening structure includes a structure that generates a sound different in phase from the leakage sound entering through the opening.

(11) The audio processing device according to any one of (1) to (7), in which
the sound deadening structure includes a main tube including the opening and a side branch tube connected to the main tube.

(12) The audio processing device according to any one of (1) to (11), in which
the sound deadening structure includes a structure adapted to each of the leakage sounds of different frequencies.

(13) The audio processing device according to any one of (2) to (5), in which
the sound deadening structure includes the same material as of the earpiece or resin.

(14) The audio processing device according to any one of (2) to (5), in which
the leakage sound includes a sound leaking from between the sound conduit or the earpiece and an ear canal.

(15) The audio processing device according to claim 1, configured as a hearing aid or a sound collector.

(16) An information processing method including:
determining whether or not a sealing state is achieved, the sealing state corresponding to a state where a part of an ear canal is sealed by a housing included in an audio processing device or an earpiece attached to the audio processing device; and
making a notification recommending use of a sound deadening structure that reduces a leakage sound leaking through an unsealed part in a case where the sealing state is not achieved.

(17) The information processing method according to (16), in which
the notification recommending use of a sound deadening structure includes at least one of a notification encouraging use of an audio processing device formed integrally with the sound deadening structure, a notification encouraging use of an earpiece formed integrally with the sound deadening structure, or a notification encouraging attachment of the sound deadening structure to the housing or the earpiece.

(18) An earpiece including:
a tubular base;
an umbrella-shaped portion flared from a front end of the base; and
a wall forming an opening communicating with a space between the base and the umbrella-shaped portion.

### REFERENCE SIGNS LIST

20 Housing
30 Sound conduit
50 Audio output unit
60 Earpiece
61 Base
63 Umbrella-shaped portion
70, 80, 90, 120, 130, 140 Sound deadening structure
71A, 71B Wall
72, 72A, 72B, 72C, 72D, 81, 92, 122A, 122B Opening
73, 82, 93 Neck
74, 83, 94 Cavity
100, 100B, 100C Earphone device
132 Main tube
133 Side branch tube
SPA Space
SP Gap
LS Leakage sound

1. An audio processing device comprising:
an audio output unit;
a housing that houses the audio output unit;
a sound guiding portion that guides a sound output from the audio output unit; and
a sound deadening structure, wherein
the sound deadening structure includes an opening into which a leakage sound, of the sound output from the sound guiding portion, traveling around an outside of a pinna enters.

2. The audio processing device according to claim 1, wherein
an earpiece is attachable to the sound conduit, and
the sound deadening structure is arranged in a space formed between a base and an umbrella-shaped portion, both belonging to the earpiece, with the earpiece attached.

3. The audio processing device according to claim 2, wherein
the sound deadening structure is integrally formed with the earpiece attached to the sound conduit.

4. The audio processing device according to claim 2, wherein
the sound deadening structure is integrally formed with the sound conduit.

5. The audio processing device according to claim 2, wherein
the sound deadening structure is detachably attached to the space.

6. The audio processing device according to claim 1, wherein
the sound deadening structure is integrally formed with the housing.

7. The audio processing device according to claim 1, wherein
a level of the leakage sound entering through the opening is reduced by the sound deadening structure.

8. The audio processing device according to claim 1, wherein
the sound deadening structure includes a neck communicating with the opening, and a cavity having a volume equal to or larger than a volume of the neck.

9. The audio processing device according to claim 1, wherein
the sound deadening structure includes a cavity communicating with the opening.

10. The audio processing device according to claim 1, wherein
the sound deadening structure includes a structure that generates a sound different in phase from the leakage sound entering through the opening.

11. The audio processing device according to claim 1, wherein
the sound deadening structure includes a main tube including the opening and a side branch tube connected to the main tube.

12. The audio processing device according to claim 1, wherein
the sound deadening structure includes a structure adapted to each of the leakage sounds of different frequencies.

13. The audio processing device according to claim 2, wherein
the sound deadening structure includes a same material as of the earpiece or resin.

14. The audio processing device according to claim 2, wherein
the leakage sound includes a sound leaking from between the sound conduit or the earpiece and an ear canal.

15. The audio processing device according to claim 1, configured as a hearing aid or a sound collector.

16. An information processing method comprising:
determining whether or not a sealing state is achieved, the sealing state corresponding to a state where a part of an ear canal is sealed by a housing included in an audio processing device or an earpiece attached to the audio processing device; and
making a notification recommending use of a sound deadening structure that reduces a leakage sound leaking through an unsealed part in a case where the sealing state is not achieved.

17. The information processing method according to claim 16, wherein
the notification recommending use of a sound deadening structure includes at least one of a notification encouraging use of an audio processing device formed integrally with the sound deadening structure, a notification encouraging use of an earpiece formed integrally with the sound deadening structure, or a notification encouraging attachment of the sound deadening structure to the housing or the earpiece.

18. An earpiece comprising:
a tubular base;
an umbrella-shaped portion flared from a front end of the base; and
a wall forming an opening communicating with a space between the base and the umbrella-shaped portion.
